(19) United States
(12) Patent Application Publication
(10) Pub. No.: US 2004/0204995 A1
(43) Pub. Date: Oct. 14, 2004

(54) Website system for managing commercial points

(75) Inventors: Jen-Hwang Weng, Jungli City (TW); Jung-Sheng Lin, Kaohsiung (TW); Shu-Chun Liu, Jungli City (TW); Ching-Mao Yeh, Miaoli (TW)

Correspondence Address: BRUCE H. TROXELL, SUITE 1404, 5205 LEESBURG PIKE, FALLS CHURCH, VA, 22041, US

(73) Assignee: Jen-Hwang WENG

(21) Appl. No.: 10/778,399

(22) Filed: Feb. 17, 2004

(30) Foreign Application Priority Data
Feb. 18, 2003 (TW) 92103261

(51) Int. Cl. G06F 17/60

(52) U.S. Cl. 705/14; 709/204

(57) ABSTRACT

A website system is used for managing a plurality of commercial points. The website system conveys a predetermined amount of commercial points from a user to an acceptor according to a conveying message. The conveying message comprises an identification data of the acceptor and the amount of the predetermined commercial points. The website system comprises a memory, a conveying mechanism, and a notifying mechanism. The memory at least records a user's data. The user's data at least comprises an identification data of the user and an amount of at least one kind of commercial points under the user's name. The conveying mechanism receives the conveying message and conveys the predetermined amount of commercial points form the user to the acceptor. The notifying mechanism generates a conveying message and, according to the identification data of the acceptor in the conveying message, delivers the conveying message to the acceptor via a network communication mechanism.

### BACKGROUND OF THE INVENTION

1. Field of the invention

This present invention utilizes network communication to provide a fast method and system to convey commercial points on-line.

Commercial points, also known as consumption points or bonus points, are created by a merchant to expedite consumption or to feedback consumers. The merchant allots commercial points to his/her customers in accordance with the quantity of consumption, the frequency of consumption, etc. When a consumer accumulates a predetermined quota of commercial points, he/she can use it to exchange preferential goods or a preferential price. Some merchants may provide token money instead of real money for trading security or for special objective of commercial operation. Consumers can purchase the token money by real money and utility the token money to join commercial activities hold by the merchant. By this way, the token money can also be considered as one of another commercial points.

The commercial points described above could be classified into marketing points or token points. The marketing points, such as coupon or gift miles, are allotted for marketing purposes. The token points, such as book token, on-line game points, or gift token of a particular department store, can be purchased by the consumer and can be used to consume. Either marketing points or token points can be nominal points or non-nominal points. Nominal points are allotted to a specific consumer with consumer's identification, while the non-nominal points aren't. The coupon is always treated as a non-nominal point, but the gift miles on the other hand is usually a nominal one. For another example, the book token is a non-nominal point, but on-line game point is a nominal point.

2. Description of the Prior Art

Some of the aforesaid commercial points can be conveyed to another person, but some can't due to lacking a mechanism to perform the conveying. Consumers can convey non-nominal points directly through delivering. Yet, such a direct conveying method is obviously inconvenient and can't be performed in real-time. Moreover, the gift certificates or the coupons in the computerized daily life are easy to be neglected and even to through away absentmindedly. Regarding the nominal points, if a mechanism to convey does not exist, then the nominal points would mean nothing in case that the owner of the nominal points didn't continue join the commercial activity or the nominal points do not be accumulated to a specific quota. In the above description, commercial points are definitely hard to be conveyed or transferred in real-time. That is, the customer's right to materialize the commercial points is not well protected.

### SUMMARY OF THE INVENTION

Internet nowadays has been integrated into ordinary life. People can link easily to a website and join activities on-line. To courage people to join the activities and to assure the security of on-line trade, the website is preferable to provide commercial points for marketing or token trade. The difference between the real world and the network is the commercial points in Internet can only be nominal. That's because commercial points cannot be assigned to a user without identification data in Internet.

To have the conventional commercial points be capable of being conveyed through networking, the website of the present invention thus provide a more convenient, faster and real-time conveying mechanism for its consumer to convey extra commercial points to friends for asserting his/her own right or interest. Besides, the merchant and his/her products can thereby raise their appearance rate in the networking. Also, the conveying mechanism of the present invention can better keep the commercial interest of the consumer for he/she can have another way to collect enough commercial points over a specific quota. Through the denoting mechanism and the conveying performed, the merchant can be shown to more users on-line, and thus can contribute to expand the merchant's appearance and reputation in Internet. Definitely, an increase in number of customers can be foreseen.

In the prior art, a user can play the on-line game by consuming his/her nominal points of the on-line game. Yet, if the user doesn't play the on-line game anymore, the user will just lose the remnant points which can't be conveyed to others. By providing the present invention, upon meeting the same situation, the user can convey his/her own nominal points to friends. Through the conveying invention of the present invention, the interest of the user can thus be ensured. If an acceptor were an old customer, the present invention would help the merchant to promote the acceptor's loyalty. On the other hand, if the acceptor were a new customer, the present invention would help the merchant to create a new customer. In another embodiment, the present invention could make the merchant to issue a virtual coupon to a customer which can be conveyed to friends on-line or can buy a real or virtual book. By applying the present invention, the virtual coupon wouldn't be lost or defaced so that the customer could do real-time consumption and real-time donation.

### BRIEF DESCRIPTION OF THE APPENDED DRAWINGS

FIG. 1 is a schematic diagram of the embodiment of the present invention;

FIG. 2 is a block diagram of the website system in FIG. 1; and

FIG. 3 is a flow chart of conveying commercial points of the present invention.

### DETAILED DESCRIPTION OF THE INVENTION

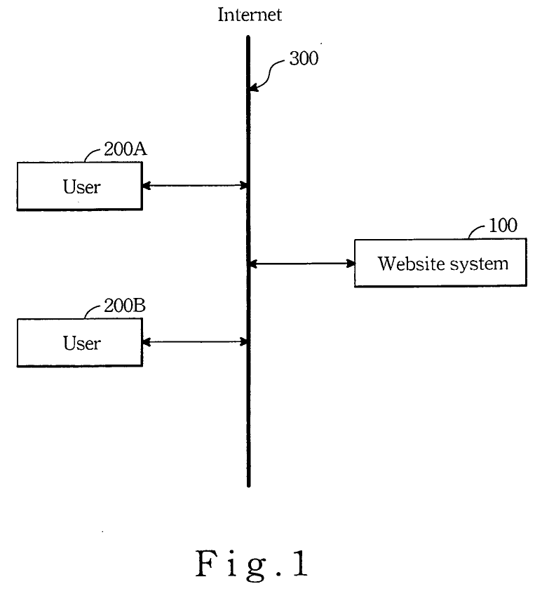

The present invention is to utilize the convenient network communication to provide a website system for the user to convey the nominal commercial points in real-time. The present invention creates a new commercial points managing model for a plurality of users to quickly and easily convey their nominal points to other users. Referring now to FIG. 1, a schematic diagram of the embodiment of the present invention is shown. In the present invention, a plurality of users 200 can enter the website system 100 through the Internet 300 to proceed a conveying behavior through which the commercial points can be conveyed out on-line.

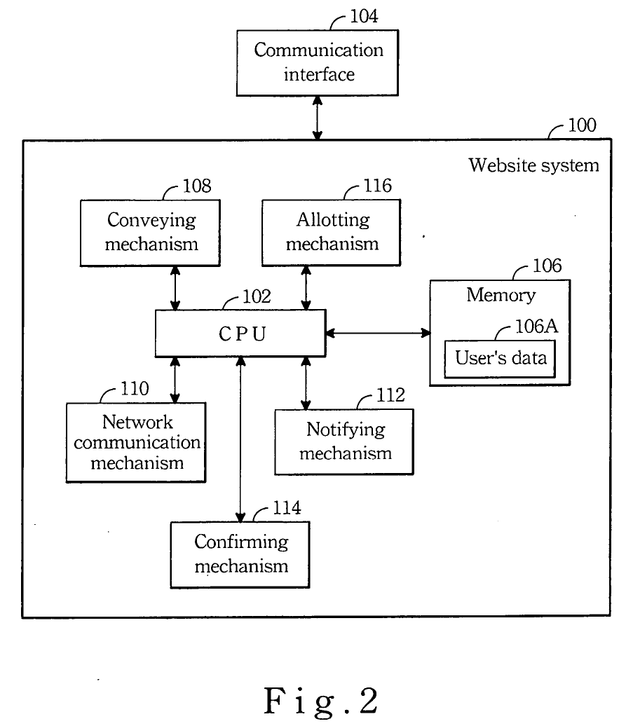

Referring to FIG. 2, a block diagram of the website system 100 in FIG. 1 is shown. The website system 100 of the present invention at least comprises a central process unit (CPU) 102, a communication interface 104, a memory 106, a conveying mechanism 108, a network communication mechanism 110, a notifying mechanism 112, and a confirming mechanism 114. The CPU 102 is used for operational processing per other elements' request. The communication interface 104 is used for linking the communication link to make the website system 100 linkable with outer computers. The communication link could be one of the followings: Local Area Network (LAN), Internet, Wireless Local Area Network (WLAN) or the like. The memory 106 at least records a user's data 106A. The user's data at least comprises an identification data, an Internet communication address, and every item of the commercial points under the user's name. The identification data of the user could be a user's ID number, an e-mail address, an MSN Messenger address, an ICQ address or any other data which can confirm the user himself. The conveying mechanism 108 is able to receive a conveying message. The conveying message comprises user's identification data, an acceptor's identification data, and a predetermined amount of commercial points to be conveyed. The conveying mechanism 108 conveys the predetermined amount of commercial points from the user's data 106A to the acceptor according to the conveying message. The network communication mechanism 110 could be one of the followings: an e-mail mechanism, an ICQ, an MSN Messenger or any other mechanism which could delivery message in the Internet. The notifying mechanism is used for generating a conveying message to notifying the acceptor through the network communication mechanism 110, according to acceptor's network communication address comprised in the conveying message.

The website system also comprises a confirming mechanism for receiving the identification data of the acceptor and then providing a confirming process for the acceptor to confirm the conveying behavior. The identification data of the acceptor could be an acceptor's ID number, an e-mail address, an MSN Messenger address, an ICQ address or any other data which can be used to confirm the acceptor. If the acceptor does not accept the conveying behavior or the acceptor can not confirm the conveying behavior in a preset period, the conveying behavior would be failed and the predetermined amount of commercial points would be returned to the user.

When the user's data 106A does not comprise the acceptor's data during the conveying behavior, the conveying mechanism 108 is further used to receive the acceptor's network communication address provided by the donator and record the relating data about the acceptor into the user's data 106A. Then, the conveying mechanism 108 can convey the predetermined amount of commercial points from the donator to the acceptor. The notifying mechanism 112 also use the acceptor's network communication address provided by the donator to delivery the conveying message through the network communication mechanism 110.

Moreover, the conveying message delivered by the notifying mechanism 112 is further linked to the confirming mechanism 114. Thereby, the acceptor can link to the confirming mechanism 114 for confirming the conveying behavior while receiving the conveying message.

In another embodiment of the present invention, the website system 100 further comprises an allotting mechanism 116 for the user to allot extra points to user's friends. The allotting mechanism 116 can let the user quickly convey the extra points on-line and make the merchant's product information well known.

The points described above can be nominal consuming points, nominal token points or the like which can be used for consuming.

The present invention provides the user a mean to convey the commercial points on-line. The present invention can positively activate the relating business activities. For consumers, because the bitty points can thereby be collected, the consumer can assure the interest and would be happy to join the business activity which provides the commercial points. The commercial points are not conveyed or traded in a real material, so that the commercial points are easy to preserve and won't be damaged or lost. This also helps to assure the consumer's interest. Moreover, due to the convenience of the networking, the donator's goodwill will delivered to the acceptor in real-time and then the acceptor can consume with the points at any convenient time, even in real-time. For the merchant, if the conveying behavior can be performed in each business activities, the merchant can also advertise at every business activity. Even the consumer does not convey in a particular business activity, yet the merchant can also be renown by others' conveying behaviors. Upon such an arrangement, the individuality of the “non-friction business” of Internet can then be provided. Besides, if the merchant allots some extra points to his/her friends, the name of the product could be also promoted. In either case, the conveying behavior could make both the consumer and the merchant benefit from such business activities.

In the above description, the conveying behavior can definitely help to activate the business activities. In Internet and the present invention, the commercial points can be conveyed arbitrarily, the user would be willing to join the business activities, and the merchant would get the biggest benefit from issuing the commercial points.

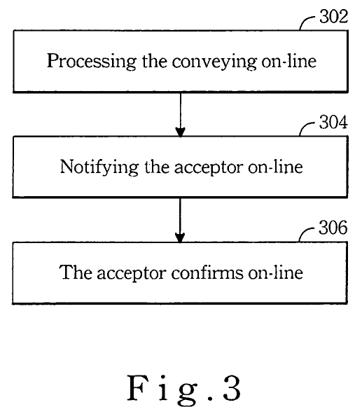

Referring to the FIG. 3, a flow chart of conveying commercial points of the present invention is shown. The conveying process comprises the following steps.

First, the denoting process of the present invention is to process the conveying on-line (step 302).

In this embodiment, the user's data 106A comprises at least an identification data, an Internet communication address, and commercial points under the user's name. The donator can log into the website system 100 and then input the ID of the acceptor as well as the predetermined amount of commercial points to be conveyed. The website system 100 can then generate a conveying message according to the donator's inputting. The conveying mechanism 108 receives the conveying message and conveys the predetermined amount of commercial points from the donator to the acceptor according to the conveying message. When the user's data 106A does not comprise the acceptor's data, the conveying mechanism 108 can be further used to receive the acceptor's network communication address provided by the donator and to record the relating data about the acceptor into the user's data 106A. Then, the conveying mechanism 108 could convey the predetermined amount of commercial points from the donator to the acceptor. The conveying mechanism 108 can be preferably designed by using the ASP (Active Server Page) program. Moreover, the website system 100 further comprises an allotting mechanism 116 for allotting extra points from the user to his/her friends. The allotting mechanism 116 can be also designed by the ASP program.

Secondly, the present invention is to notify the acceptor on-line (step 304)

The notifying mechanism 112 is used for generating a conveying message to notifying the acceptor through the network communication mechanism 110 (in the present embodiment is an e-mail mechanism), according to the acceptor's network communication address comprised in the conveying message. When the user's data 106A does not comprise the acceptor's data, the notifying mechanism 112 can use the acceptor's network communication address provided by the donator to delivery the conveying message through the network communication mechanism 110. The notifying mechanism 112 is designed by using the CDONTS object comprised in the ASP (Active Server Page) program. The CDONTS object can design to generate a conveying message and drive the e-mail mechanism to deliver the notifying message to the acceptor.

Thirdly, the present invention is that the acceptor confirms on-line (step 306)

Confirming mechanism 114 receives the identification data of the acceptor and then provides a confirming process for the acceptor to confirm the conveying behavior. The identification data of the acceptor could be an acceptor's ID number, an e-mail address, an MSN Messenger address, an ICQ address or any other data which can confirm the acceptor himself. If the acceptor does not accept the conveying behavior or the acceptor does not confirm the conveying behavior in a preset duration, the conveying behavior would be failed and the predetermined amount of commercial points would be returned to the user. When the user's data 106A does not comprise the acceptor's data, the notifying mechanism 112 can also use the acceptor's network communication address provided by the donator to delivery the conveying message through the network communication mechanism 110. Moreover, the conveying message delivered by the notifying mechanism 112 further comprises a hyperlink object to link to the confirming mechanism 114. Thereby, the acceptor is able to link to the confirming mechanism 114 in order to confirm the conveying behavior upon receiving the conveying message. The allotting mechanism 116 can be also designed by using the ASP program.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A website system for managing a plurality of commercial points and for conveying a predetermined amount of commercial points from an user to an acceptor according to a conveying message, the conveying message comprising an identification data of the acceptor and the predetermined amount of the commercial points, the website system comprising:
a memory, at least recording an user's data, the user's data at least comprising an identification data of the user and an amount of at least one commercial point under the user's name;
a conveying mechanism for receiving the conveying message and conveying the predetermined amount of commercial points from the user to the acceptor; and
a notifying mechanism for generating a conveying message and, according to the identification data of the acceptor in the conveying message, for delivering the conveying message to the acceptor via a network communication mechanism.

2. The website system of claim 1, wherein the identification data of the user is selected at least one from the group consisted by an identification number, an e-mail address, an ICQ address, and an MSN address.

3. The website system of claim 1, further comprising an allotting mechanism for allotting commercial points from the user to the acceptor on-line.

4. The website system of claim 1, wherein, if the memory doesn't recording the relating data of the acceptor, the conveying mechanism further adds an acceptor's data into the memory.

5. The website system of claim 1, further comprising a confirming mechanism for receiving the identification data of the acceptor and then providing a confirming process for the acceptor to confirm the conveying behavior.

6. The website system of claim 5, wherein the conveying message further provides the acceptor to link the confirming mechanism on-line to confirm the conveying behavior.

7. The website system of claim 1, wherein the commercial point is selected one kind of the commercial points from a group consisted by a nominal consume point and a nominal token point.

8. The website system of claim 1, wherein the network communication mechanism is selected from a group consisted by an e-mail mechanism, an ICQ mechanism, and an MSN Messenger mechanism.

9. The website system of claim 1, wherein the identification data of the acceptor is selected from the group consisted by an ID, an e-mail address, an ICQ address, and an MSN address.
